(19) United States
(12) Patent Application Publication
(10) Pub. No.: US 2013/0073874 A1
(43) Pub. Date: Mar. 21, 2013

(54) INTERFACE APPARATUS AND METHOD FOR ETHERNET POWERED DEVICE

(71) Applicant: Ali Eghbal, San Diego, CA (US)

(72) Inventor: Ali Eghbal, San Diego, CA (US)

(21) Appl. No.: 13/236,634

(22) Filed: Sep. 19, 2011

(51) Int. Cl. G06F 1/26

(52) U.S. Cl. 713/300

(57) ABSTRACT

A system, topology, and methods for providing an interface module between a powered device (PD) and power sourcing equipment (PSE) in POE architecture, the interface module coupling the PSE to the PD and a listening device.

### TECHNICAL FIELD

Various embodiments described herein relate to apparatus employed in power over Ethernet (POE) systems or architecture.

### BACKGROUND INFORMATION

It may be desirable to provide an interface module between a powered device (PD) and power sourcing equipment (PSE) in POE architecture. The present invention provides such a device.

### BRIEF DESCRIPTION OF THE DRAWINGS

FIG. 1A is a simplified diagram of Ethernet architecture including a PSE and a PD according to various embodiments.

FIG. 1B is a simplified diagram of another Ethernet architecture including a PSE and a PD according to various embodiments.

FIG. 2A is a simplified diagram of Ethernet architecture shown in FIG. 1A including an interface apparatus according to various embodiments.

FIG. 2B is a simplified diagram of Ethernet architecture shown in FIG. 1B including an interface apparatus according to various embodiments.

FIG. 3A is a block diagram of a POE interface apparatus according to various embodiments.

FIG. 3B is a block diagram of a POE interface apparatus according to various embodiments.

FIG. 4 is a flow diagram illustrating several methods according to various embodiments.

FIG. 5 is a block diagram of a voltage threshold module according to various embodiments.

### DETAILED DESCRIPTION

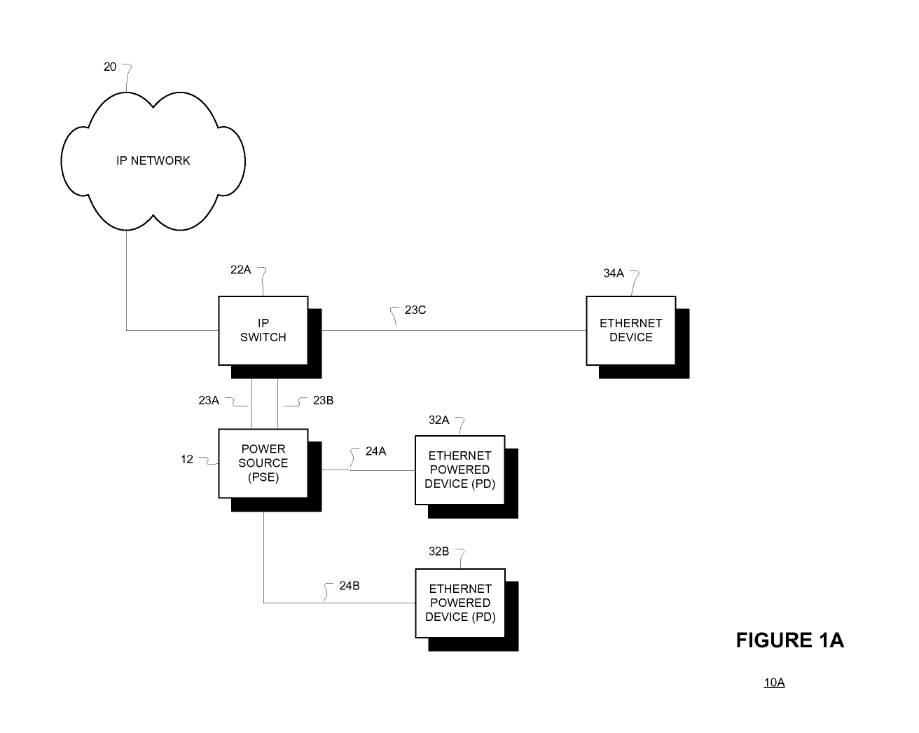

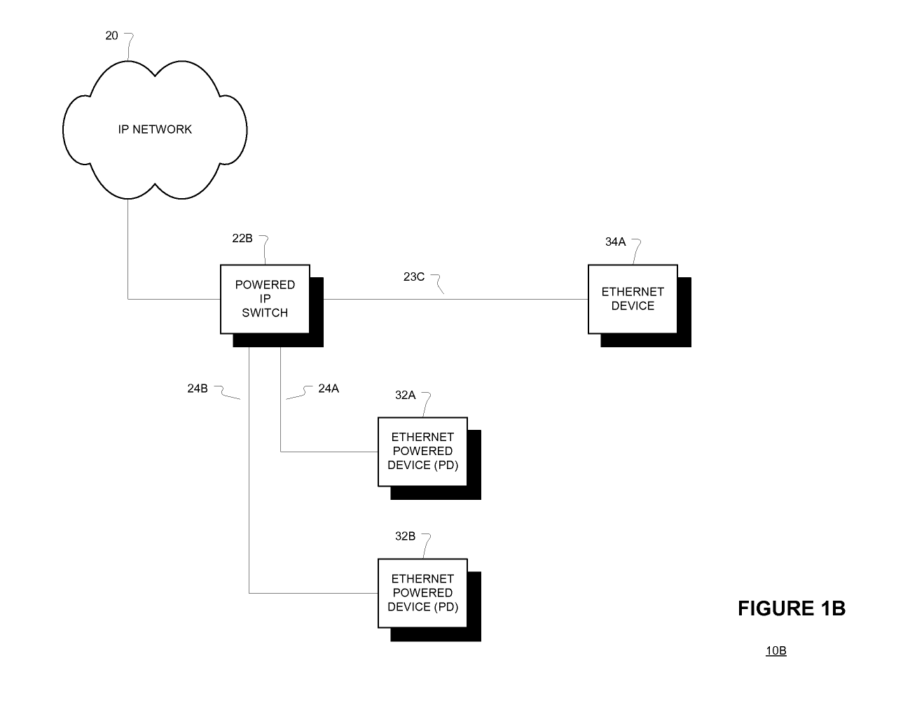

FIG. 1A is a simplified diagram of Ethernet architecture 10A according to various embodiments. Architecture 10A may include an internet protocol (IP) network 20, an IP switch 22A, a Power Source (PSE) 12, at least one Ethernet powered device (PD) 32A, 32B, and an Ethernet device 34A. The IP network 20 may communicate data using an internet protocol with devices coupled to the network 20. The IP network 20 may be a network of networks including the global Internet. The IP switch 22A may enable communication between one or more devices 32A, 32B, 34A with the IP network 20 or other devices coupled to the IP switch 22A. One or more devices 32A, 32B, 34A may be coupled to the Ethernet architecture 10A via an Ethernet wire or cable 23A, 23B, 23C, commonly including 4 wired pairs. The Ethernet wires commonly have rating based in Institute of Electrical and Electronics Engineers (IEEE) standards such as a category 3, 5 or 6 cable.

IP devices 32A, 32B, 34A commonly require a power source to operate. Common Ethernet cabling provides data differentially over two or four pairs, wires 1-2, 3-6, 4-5, and 7-8. In order to reduce infrastructure and wiring costs to provide power to an Ethernet device 32A, 32B, architecture 10A may provide power on one or more Ethernet wires coupled to the Ethernet device 32A, 32B, termed a powered device (PD). Power over Ethernet cabling 24A 24B may be provided according to one or more IEEE standards including 802.3af called Power over Ethernet (PoE) standard and 802.3at PoE+ or PoE plus. The 802.af may provide power up to 15.4 W DC (minimum 44V DC and 350 mA) and the 802.at may provide power up to 25.5 W DC. A device that provides power on an Ethernet network 10A may be located on a network node such as device 12 termed power sourcing equipment (PSE). A PSE 12 located at a network node or between several nodes is called a mid-span device. In an embodiment the PSE 12 may receive one or more Ethernet signals via cables 23A, 23B. The PSE 12 may insert power onto one or more Ethernet signals to provide POE signals 24A, 24B to the Ethernet powered devices (PD) 32A, 32B.

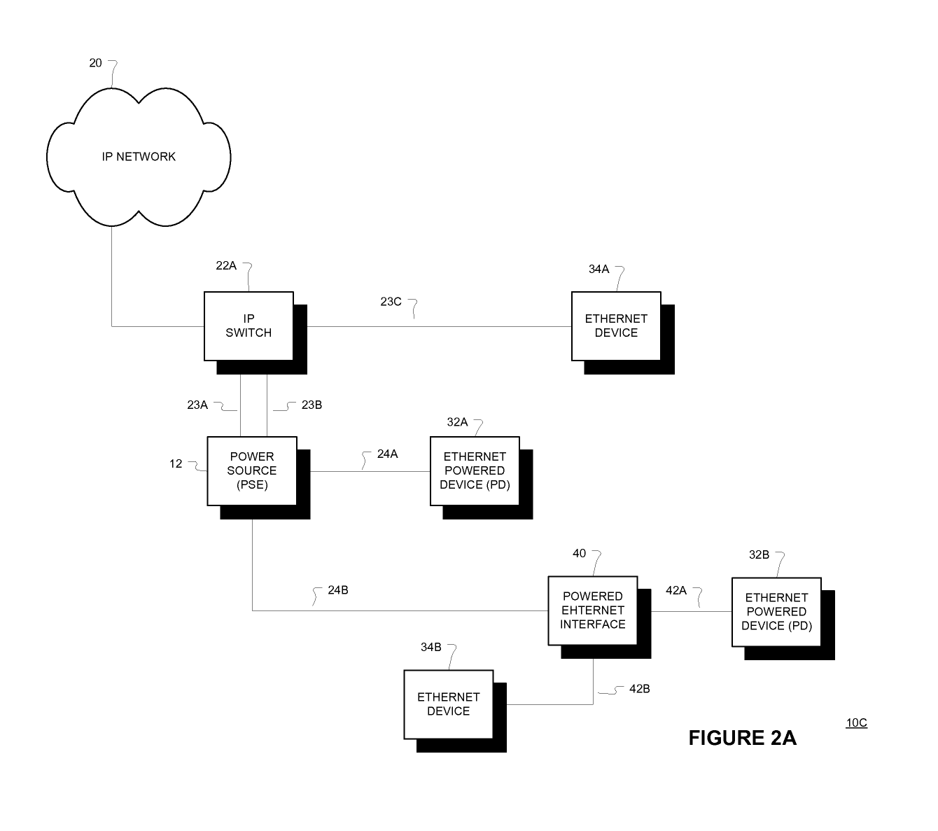

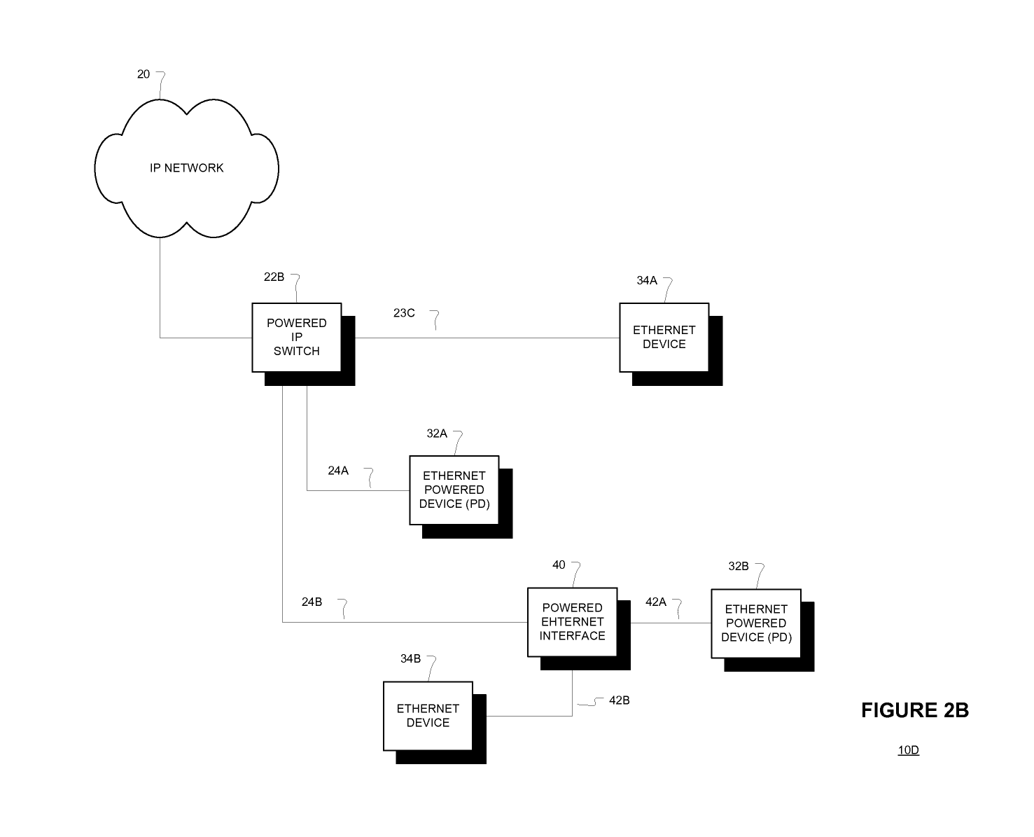

A Ethernet PD 32A, 32B may receive sufficient power to operate without access to another power source. A PD 32A, 32B may include IP telephones, wireless LAN access points, IP Cameras, remote Ethernet switches, embedded computers, thin clients and LCDs. A PSE may also be co-located in a switch, router, or other network communication device 22B such as shown in FIG. 1B in architecture 10B. Such a device 22B is termed an end-span device. The IP switch 22B in FIG. 2B may include power sourcing for an Ethernet device coupled to a specific port (POE port) or sense that a coupled device 32A, 32B is a POE device according to one or more protocols such as IEEE 802.3af and 802.3at. A PSE 12 may similarly sense that a coupled device 32A, 32B is a POE device (PD) according to one or more protocols such as IEEE 802.3af and 802.3at and provide power on two or four pairs of the Ethernet cable 24A coupling the PSE 12 to the sensed PD 32A, 32B.

It is noted a PSE 12 or IP switch 22B may provide power on wire pairs also used to carry data, known as a phantom power technique (Mode A), on the spare wires (Mode B), or on all sets of wires. Such a configuration may enable a PSE 12 or IP switch 22B providing POE to operate or communicate data in a 10BASE-T, 100BASE-TX, and 1000BASE-T format, which uses four sets of wires to communicate data. It is further noted that power provided on data pairs must be polarized according to IEEE 802.3af and 802.3at. POE power provided on spare pairs (non-data pairs) may be non-polarized. As noted for a 10BASE-T and 100BASE-TX communication system, data pairs are wires 1-2, 3-6 with wires 4-5 and 7-8 act as spares. In a 1000BASE-TX communication system, data pairs are wires 1-2, 3-6, 4-5 and 7-8. It is further noted that a PSE 12, powered IP switch 22B may provide different power levels based on a negotiation protocol between the PSE 12, powered IP switch 22B and a PD 32A, 32B. The 802.3af protocol may support three power class levels and the 802.3at protocol may support four power classes or a variable power level having 0.1 W increments.

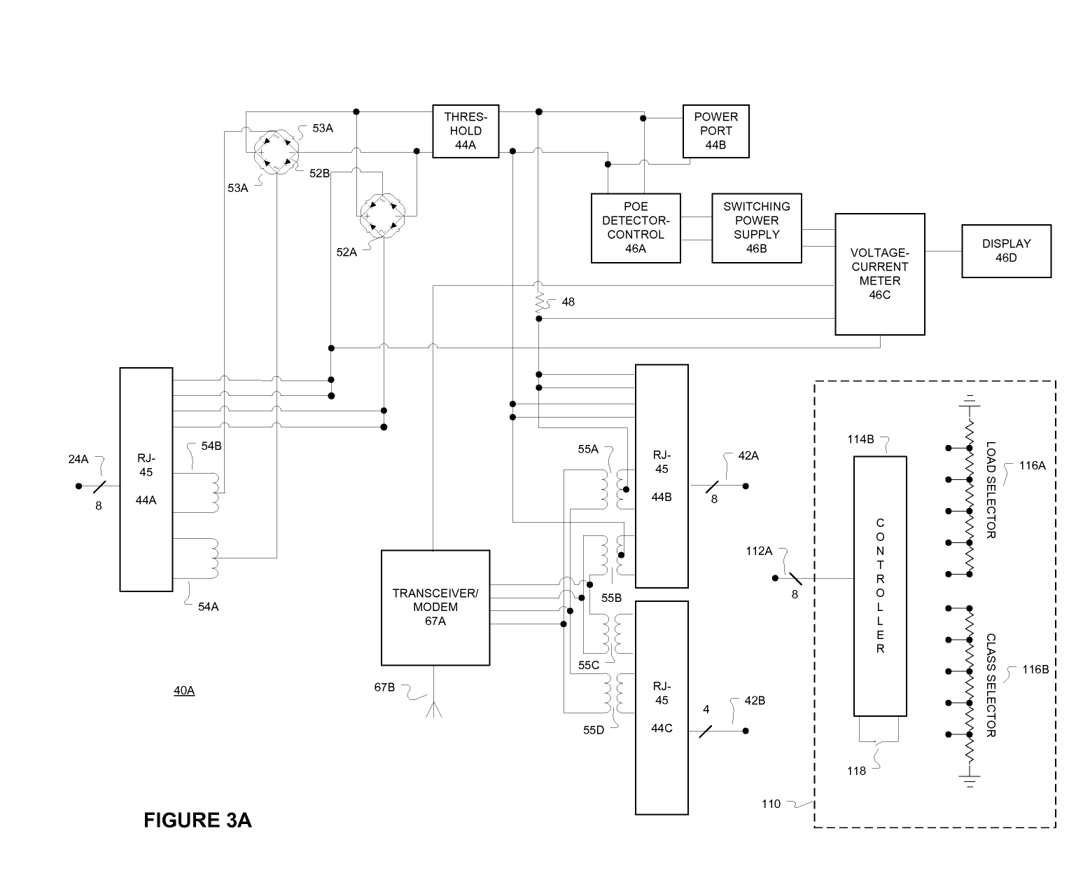

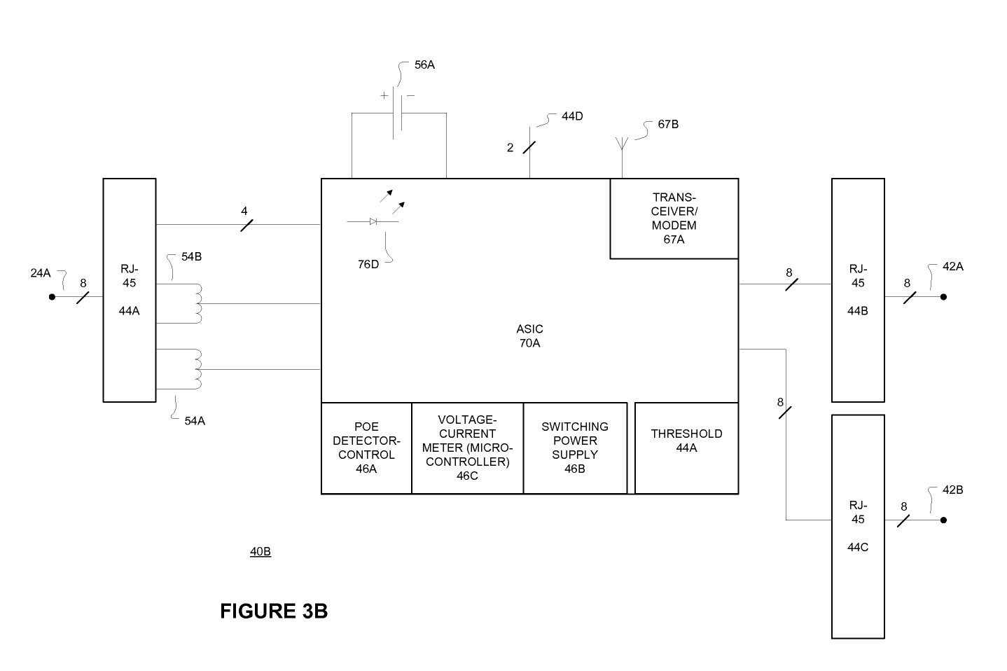

A PD 32A, 32B may indicate it is POE standard compliant by placing a 25 kOhm resistor (sense resistance) between a powered pair. The PDF 32A, 32B may provide other sense resistances as function of desired power level. A PD 32A, 32B may indicate non-operation or no power requirements by shorting the powered pair. In an embodiment a PSE 12 may provide power to two PDs 32A, 32B via two Ethernet wires. Given all the variations it may be desirable to provide an interface 40 (FIG. 2A, 2B), 40A (FIG. 3A), 40B (FIG. 3B) between a PSE 12, powered IP switch 22B or other PSE device and a PD 32A, 32B to be able to setup, debug, or maintain the operation of the PD 32A, 32B, the PSE 12, powered IP switch 22B, or the wires coupling same 24A, 24B.

The interface 40, 40A, 40B may further enable data generated by the PD 32A, 32B to be communicated to the interface 40, 40A, 40B and an Ethernet device 34B coupled to the interface 40, 40A, 40B via a wired (42B) or a wireless connection (67A). Further the interface 40, 40A, 40B may further enable data on the wires 24A, 24B to be received by the PD 32A, 32B to also be communicated to the interface 40, 40A, 40B and an Ethernet device 34B coupled to the interface 40, 40A, 40B via a wired (42B) or a wireless connection (67A). As shown in FIG. 2A an interface apparatus 40 according to various embodiments may be located between the PSE 12 and a PD 32B. An Ethernet device 34B may also be coupled to the interface 40 via a wire 42B (FIG. 3A) or wirelessly (FIG. 3B). The PSE 12 may be coupled to the interface 40 via an Ethernet wire 24B. The interface 40 may be coupled to the PD 32B via an Ethernet wire 42A.

As discussed a PD 32A, 32B may employ various protocols to communicate their needs for power and desired power level to a PSE 12. An interface 40, 40A, 40B may need to negotiate power requirements for a PD 32A, 32B and enable the coupling between a PSE 12 and PD 32A, 32B while maintaining protocol(s) required by the PSE 12 and PD 32A, 32B under PoE standards (IEEE 802.3af, 802.3at) when the PD 32A, 32B is not coupled to the interface module 40. Similarly as shown in FIG. 2B an interface apparatus 40 according to various embodiments may be located between the powered IP switch 22B and a PD 32B. An Ethernet device 34B may also be coupled to the interface 40 via a wire 42B (FIG. 3A) or wirelessly (FIG. 3B). The powered IP switch 22B may be coupled to the interface 40 via an Ethernet wire 24B. The interface 40 may be coupled to the PD 32B via an Ethernet wire 42A.

FIG. 3A is a block diagram of a PoE interface apparatus 40A according to various embodiments. As shown in FIG. 3A the PoE interface apparatus 40A may include an upstream RJ45 connector 44A, a downstream RJ45 connector 44B, a listening port RJ45 connector 44C, a power port 44D, a first diode bridge 52A, a second diode bridge 52B, several center tap transformers 54A, 54B, signal transformer pairs with center tap 55A, 55B, signal transformer pair 55C, 55D, a voltage threshold module, a PoE detector-control module 46A, a switching power supply module 46B, a voltage-current meter module 46C, a display module 46D, a resistor 48, a transceiver/modem 67B, and an antenna 67A. The upstream RJ45 connector 44A is configured to be coupled to a PSE 12 or a powered switch 22B. The downstream RJ45 connector 44B is configured to be coupled to a powered device (PD) (PoE powered device) 32A, 32B. The RJ45 listening port connector 44C may be coupled to an Ethernet device 34D that may monitor data generated by the PD 32A, 32B. It is noted that the RJ45 jacks 44A, 44B, and 44C and DC port 44D may be embedded in the interface apparatus 40, 40A, 40B or separated by wire in a pigtail configuration (some or all of the jacks 44A, 44B, and 44C). The power connector 44D may be coupled to a power cable and communicate power present on the upstream RJ45 port 44A.

In an embodiment a four switches 53A may be coupled to the diode bridges 52A, 52B to reduce the voltage drop across the diode bridges 52A, 52B when biased in a first and a second forward mode as a function of the received signal polarity. The transformers 54A, 54B may couple the common mode power applied to the spare differential wire pairs via a center tap to the second diode bridge 52B. The diode bridge 52B and switches 53A may switch the polarity of the power signal received on the differential pairs to a positive or negative polarity regardless of the received power signal polarity. The diode bridge 52B and switches 53A also prevents power feedback to the transformers 54A, 54B. The diode bridge 52A and switches 53A is coupled to the data differential pair. The diode bridge 52A couples any power on the data differential pair (Mode B) to the any power on the spare differential pair (Mode A). The diode bridge 52A and switches 53A also prevents power feedback to the data differential pair.

In an embodiment a voltage threshold module 44A may couple the received power (from the diode bridges 52A, 52B) to the power port 44B, downsteam RJ-45 connector 44B, and the POE detector-control module 46A. The voltage threshold module 44A may present a load to the PSE 12 coupled to the upstream connector 44A and prevent power transfer to the remainder of the interface module 40A until a predetermined minimum voltage level is provided on the upstream connector 44A. In an embodiment the predetermined minimum voltage level is about 30 Volts. FIG. 5 is diagram of circuit module 120 that may be employed as a voltage threshold module 44A in an embodiment.

As shown in FIG. 5 the circuit module 120 may include capacitors 122A, 122B, 122C, resistors 124A, 124B, 124C, 124D, zener diode 128, NPN bipolar transistor 126B, and PNP bipolor transistor 126A. In an embodiment the capacitor 122A may a capacitance of about 0.10 g, the capacitors 122B, 122C may a capacitance of about 0.01 g. The resistors 124A, 124D may a resistance of about 22.1 Kohms and the resistors 124B, 124C may a resistance of about 33 Kohms. The Zener diode 128 may have a threshold or breakdown voltage of about 15 Volts. In combination with the resistors 124A, 124B and the inherent resistance of the Zener diode 128, the Zener diode 128 may not operate or breakdown until a voltage about 30 Volts is present at Vin.

In an embodiment once the Zener diode 128 is biased forward (breaks down) current will flow to the PNP bipolar transistor 126A. The PNP bipolar transistor 126A may then act as a switch and pass the signal received on Vin to Vout. Further once the PNP bipolar transistor 126A is active, current will flow the NPN bipolar transistor 126B, effectively bypassing the Zener diode 128. In an embodiment the PNP bipolar transistor 126A may be an ON Semiconductor (http://onsemi.com) PNP bipolar transistor model NSS60200, the NPN bipolar transistor 126B may be an ON Semiconductor NPN bipolar transistor model 2N3904, and the Zener diode 128 may be an ON Semiconductor Zener diode model BZX84C15L. Once the predetermined minimum voltage is present at the input of the voltage threshold module 44A, the power signal received by the upstream connector 44A will be coupled to the remainder of the interface module 40A.

The combined power is provided to the PoE detector-control module 46A and the voltage-current meter module 46C. The PoE detector-control module 46A and switching power supply 46B may provide various resistances and shorts across a differential pair to negotiate or control PoE over the Ethernet cable 24A, 24B when a PD 32A, 32B is not coupled to the downstream port 44B. The power port 44D is coupled to the bridges 52B, 52A output to receive power on the upstream data port (RJ-45 44A).

(This section needs to be updated based on the new 3A drawing) The voltage-current meter module 46C may measure the current and voltage of PoE power on the differential wire pairs (Mode A, Mode B, or a combination thereof) via the resistor 48, and the coupling to bridge 52A. The display module 46D may show the determined current level, voltage level, and power level, alternately or simultaneously. In an embodiment any power received on the upstream port 44A (as combined by the bridges 52A, 52B may be directed to the downstream port 44B (to be coupled to a PD device 32A, 32B) via the center tap transformers pairs 55A, 55B and wire pairs Data received from the downstream port 44B may be directed to the listening port 44C via the transformers pairs 55A, 55B, 55C, 55D. In an embodiment the transformer pair 55A may couple data to the transformer pair 55D. The transformer pair 55B may couple data to the transformer pair 55C.

Data received from the downstream port 44B may also be communicated to a device 34B via a wireless signal generated by the transceiver/modem 67B and communicated on the antenna 67A. The voltage-current meter 46C measurements may also be communicated to a device 34B by the transceiver/modem 67B. The modem 67B may modulate the downstream signal(s) using a predetermined protocol and communicate the signal accordingly. The transceiver/modem 67B may also receive control signals that control the operation of the interface apparatus 40A.

In an embodiment the interface 40A may include a PD load emulator 110. The PD load emulator 110 may be a physically separate device or incorporated in the interface 40A. The PD emulator 110 may include an interface/controller 114B, a load selector 116A, a class selector 116B, and a switch 118. The controller 114B may include an RJ-45 interface 112A to enable coupling of the emulator 110 to the downstream port 44B. The controller 114B may couple the selectable load 116A and class 116B to RJ-45 interface 112A as a function of the switch 118. The class selector 116B may be a variable resistor having different levels representing different POE classes based on POE protocols. The load selector 116A may be a variable high power resistance and power module that enables a user to simulate the load of a PD 32A, 32B.

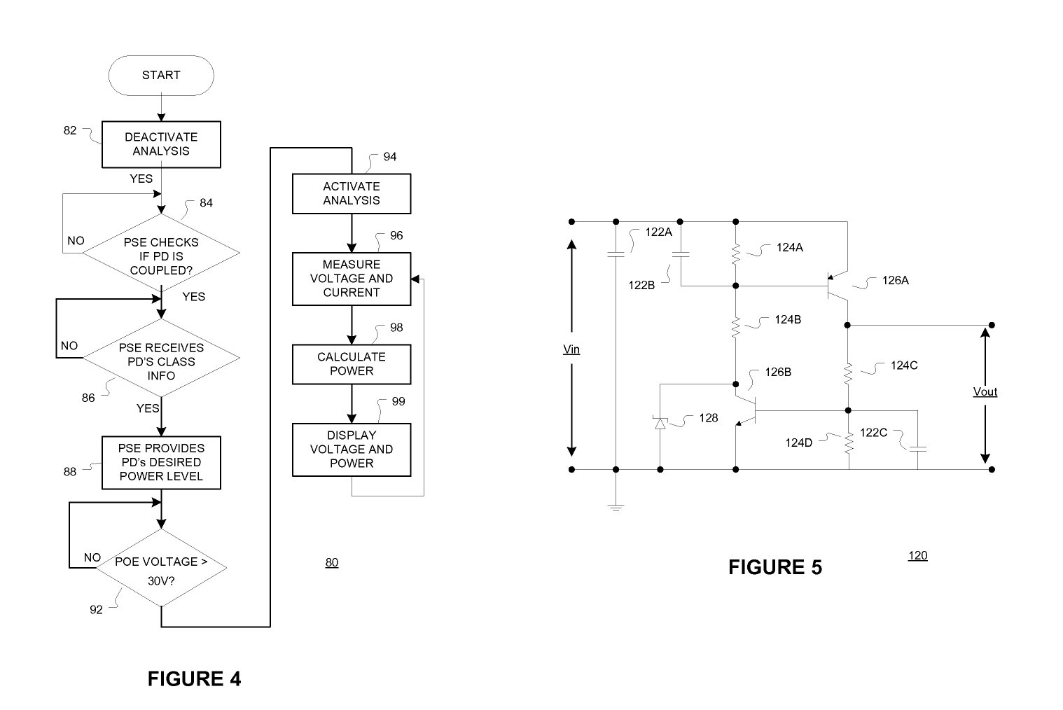

FIG. 4 is a flow diagram illustrating several methods 80 according to various embodiments that may be employed by the interface apparatus 40A, 40B, 40 in combination with a PSE 12 or 22B. In an embodiment an interface 40, 40A, 40B voltage-current meter module 46C may be deactivated (activity 82) until a minimum POE voltage is detected by the interface 40A, 40B, 40 (activity 92). A PSE 12, 22B may not provide power on Ethernet (POE) until it first detects a PD 32A, 32B coupled to the PSE 12, 22B (activity 84) and determines the PD 32A, 32B class (activity 86). In an embodiment an interface 40, 40A, 40B may provide resistance to a coupled PSE 12, 22B via POE detector-control 46A when a PD 32A, 32B or emulator 110 is not coupled to the interface 40, 40A, 40B. Otherwise when a PD 32A, 32B or emulator 110 is coupled to the interface 40, 40A, 40B, a PSE 12, 22B may detect the PD 32A, 32B and the POE detector-control 46A may not provide any resistance or load. When the interface 40, 40A, 40B detects that POE voltage level is greater than 30 volts, the interface 40, 40A, 40B may activate analysis (activity 94). The interface 40, 40A, 40B may periodically or continuously measure POE current and voltage and calculate the power (activity 96, 98) via the voltage-current meter 46C and display the measured voltage, current, and power (activity 99).

In an embodiment the interface apparatus 40, 40A, 40B may be used to enable a PD 32A, 32B to be configured remotely from the PSE 12. For example, the interface apparatus 40, 40A, 40B may be coupled between a PSE 12, 22B and a PD 32A, 32B to provide power to the PD 32A, 32B. The PD 32A, 32B may be a PoE network camera. A laptop may be coupled to the interface apparatus 40, 40A, 40B via the listening port 44C. A user via the laptop may control the operation of the network camera 32A to configure it to a desired state of operation. The interface apparatus 40, 40A, 40B may also display the power levels of the PSE 12, 22B at or near the network 32A. The PSE 12, 22B or wires 24A, 24B may be modified as necessary to ensure the needed power levels reach the network camera 32A.

FIG. 3B is a block diagram of an interface apparatus 40B according to various embodiments. As shown in FIG. 3B, the interface apparatus 40B is similar to apparatus 40A where the diode bridges 52A, 52B, transceiver-modem 67A, PoE detector-control module 46A, voltage-current meter module 46C, and switching power supply module 46B are embedded in an application specific integrated circuit (ASIC) 70A. The RJ45 jacks 44A, 44B, 44C may be coupled to the ASIC 70A. The interface apparatus 70A may further include a battery 56A to provide operating power needed by the interface apparatus 40, 40A, 40B until power from a PSE 12, 22B is received by the interface apparatus 40, 40A, 40B. The LED 76D may display the power levels of the PSE signal similar to the display module 46D.

The transceiver/modem 67A may employ a code division multiple access (CDMA), time division multiple access (TDMA), Global System for Mobile Communications (GSM), Worldwide Interoperability for Microwave Access (WiMAX) or COMSAT protocol and communicate with the electronic devices 30A to 30D using a local protocol including WiFi and Bluetooth. As known to one skilled on the art the Bluetooth protocol includes several versions including v1.0, v1.0B, v1.1, v1.2, v2.0+EDR, v2.1+EDR, v3.0+HS, and v4.0. The Bluetooth protocol is an efficient packet-based protocol that may employ frequency-hopping spread spectrum radio communication signals with up to 79 bands, each band 1 MHz in width, the respective 79 bands operating in the frequency range 2402-2480 MHz Non-EDR (extended data rate) Bluetooth protocols may employ a Gaussian frequency-shift keying (GFSK) modulation. EDR Bluetooth may employ a differential quadrature phase-shift keying (DQPSK) modulation.

The WiFi protocol may conform to an Institute of Electrical and Electronics Engineers (IEEE) 802.11 protocol. The IEEE 802.11 protocols may employ a single-carrier direct-sequence spread spectrum radio technology and a multi-carrier orthogonal frequency-division multiplexing (OFDM) protocol. In an embodiment, one or more electronic devices 30A to 30D may communicate with the EDPP 520A TMM 67A via a WiFi protocol.

The cellular formats CDMA, TDMA, GSM, CDPD, and WiMax are well known to one skilled in the art. It is noted that the WiMax protocol may be used for local communication between the one or more electronic devices 30A to 30D may communicate with the EDPP 520A TMM 67A. The WiMax protocol is part of an evolving family of standards being developed by the Institute of Electrical and Electronic Engineers (IEEE) to define parameters of a point-to-multipoint wireless, packet-switched communications systems. In particular, the 802.16 family of standards (e.g., the IEEE std. 802.16-2004 (published Sep. 18, 2004)) may provide for fixed, portable, and/or mobile broadband wireless access networks. Additional information regarding the IEEE 802.16 standard may be found in IEEE Standard for Local and Metropolitan Area Networks—Part 16: Air Interface for Fixed Broadband Wireless Access Systems (published Oct. 1, 2004). See also IEEE 802.16E-2005, IEEE Standard for Local and Metropolitan Area Networks—Part 16: Air Interface for Fixed and Mobile Broadband Wireless Access Systems—Amendment for Physical and Medium Access Control Layers for Combined Fixed and Mobile Operation in Licensed Bands (published Feb. 28, 2006). Further, the Worldwide Interoperability for Microwave Access (WiMAX) Forum facilitates the deployment of broadband wireless networks based on the IEEE 802.16 standards. For convenience, the terms “802.16” and “WiMAX” may be used interchangeably throughout this disclosure to refer to the IEEE 802.16 suite of air interface standards.

Any of the components previously described can be implemented in a number of ways, including embodiments in software. Any of the components previously described can be implemented in a number of ways, including embodiments in software. The modules may include hardware circuitry, single or multi-processor circuits, memory circuits, software program modules and objects, firmware, and combinations thereof, as desired by the architect of the architecture 10 and as appropriate for particular implementations of various embodiments. The apparatus and systems of various embodiments may be useful in applications. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion. A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A Power over Ethernet (PoE) interface, including:
an upstream Ethernet port for receiving power from a power source, the upstream port including a data wire pair and a power wire pair;
a downstream Ethernet port for communicating data with and providing power to a powered Ethernet device, the downstream port including a data wire pair and a power wire pair;
a listening Ethernet port for communicating data with an Ethernet device, the listening Ethernet port including a data wire pair;
the downstream Ethernet port data wire pair coupled the listening Ethernet port data wire pair;
a meter coupled to the power wire pair, the meter determining a characteristic of a signal on the power wire pair; and
a user perceptible display, the display showing the determined signal characteristic.

2. The PoE interface of claim 1, further including a power coupler, the coupler coupling the upstream Ethernet port power wire pair to the downstream Ethernet port power wire pair.

3. The PoE interface of claim 3, further comprising a voltage threshold module, the voltage threshold module coupled between the power coupler and the downstream Ethernet port power wire pair, the voltage threshold module preventing the passage of a voltage signal on the power coupler to the downstream Ethernet port power wire pair until the voltage signal reaches a predetermined voltage level.

4. The PoE interface of claim 1, wherein signal characteristic includes the signal's voltage and power level.

5. The PoE interface of claim 2, wherein the upstream port includes two data wire pairs and two power wire pairs.

6. The PoE interface of claim 5, wherein the downstream port includes two data wire pairs and two power wire pairs.

7. The PoE interface of claim 6, wherein the listening port includes two data wire pairs and the downstream Ethernet port data wire pairs are coupled the listening Ethernet port data wire pairs.

8. The PoE interface of claim 6, wherein the power coupler couples the upstream Ethernet port power wire pairs to the downstream Ethernet port power wire pairs.

9. The PoE interface of claim 8, wherein the power coupler includes a diode bridge.

10. The PoE interface of claim 4, wherein the display alternatively shows the signal's voltage level and the power level.

11. A Power on Ethernet (PoE) interface method, including:
coupling a upstream Ethernet port data wire pair to a downstream Ethernet port data wire pair, the upstream Ethernet port for receiving power from a power source and the downstream Ethernet port for communicating data with and providing power to a powered Ethernet device;
coupling the downstream Ethernet port data wire pair to a listening Ethernet port data wire pair, the listening Ethernet port for communicating data with an Ethernet device;
determining a characteristic of a signal on the power wire pair; and
displaying the determined signal characteristic on a user perceptible display.

12. The PoE interface method of claim 11, further including coupling the upstream Ethernet port power wire pair to the downstream Ethernet port power wire pair.

13. The PoE interface method of claim 12, further including coupling a voltage threshold module between the power coupler and the downstream Ethernet port power wire pair and employing the voltage threshold module to prevent the passage of a voltage signal on the power coupler to the downstream Ethernet port power wire pair until the voltage signal reaches a predetermined voltage level.

14. The PoE interface method of claim 13, wherein signal characteristic includes the signal's voltage and power level.

15. The PoE interface method of claim 12, wherein the upstream port includes two data wire pairs and two power wire pairs.

16. The PoE interface method of claim 15, wherein the downstream port includes two data wire pairs and two power wire pairs.

17. The PoE interface method of claim 16, wherein the listening port includes two data wire pairs and including coupling the downstream Ethernet port data wire pairs with the listening Ethernet port data wire pairs.

18. The PoE interface method of claim 16, including coupling the upstream Ethernet port power wire pairs to the downstream Ethernet port power wire pairs.

19. The PoE interface method of claim 16, including coupling the upstream Ethernet port power wire pairs to the downstream Ethernet port power wire pairs a diode bridge.

20. The PoE interface method of claim 14, including alternatively displaying the signal's voltage level and the power level.
